(19) United States
(12) Patent Application Publication
(10) Pub. No.: US 2013/0233787 A1
(43) Pub. Date: Sep. 12, 2013

(54) COMPOSITE BIOCOMPATIBLE ARTICLES MADE FROM DOPED POLYSULPHONE FILAMENTS AND A PROCESS FOR MAKING THE SAME

(71) Applicants: Jayesh R. Bellare, Mumbai (IN); Ganpat J. Dahe, Mumbai (IN)

(72) Inventors: Jayesh R. Bellare, Mumbai (IN); Ganpat J. Dahe, Mumbai (IN)

(21) Appl. No.: 13/876,617

(22) PCT Filed: Sep. 26, 2011
(86) PCT No.: PCT/IN2011/000667

§ 371 Date: May 30, 2013

(30) Foreign Application Priority Data
Sep. 28, 2010 (IN) 2697/MUM/2010

(51) Int. Cl. B01D 71/68; B01D 69/06; B01D 69/08; B01D 69/04

(52) U.S. Cl. CPC B01D 71/68; B01D 69/04; B01D 69/06; B01D 69/08
USPC 210/483; 210/500.41; 210/500.23; 210/500.1; 210/510.1; 264/13

(57) ABSTRACT

This invention relates to articles of high permeability and flux. Particularly useful in dialysis made from filaments produced from a composition of polysulphones and Vitamin ETPGS. This invention also includes a process for producing such articles.

### FIELD OF THE INVENTION

This invention is in the field of composite article such as fibre, membranes, sheets and tubes which are biocompatible and have enhanced permeability made from doped polysulphone filaments and a process for producing them. Polysulphone doped with Vitamin E TPGS are spun to produce filaments and articles made therewith exhibit selective and enhanced permeability.

### BACKGROUND OF THE INVENTION

Hemodialysis is a vital clinical process for removal of toxins such as creatinine, urea, biological metabolites and free water from blood in renal failure. The core element of hemodialysis is ultrafiltration hollow fiber membrane (HFM), which selectively permits toxins from blood via diffusive and convective transport across the membrane. Polysulphone (Psf) hemodialyzers are widely used due to its excellent membrane formation ability, chemical inertness, mechanical strength, and thermal stability, which make it one of the few biomaterials that can withstand sterilization techniques. Despite the popularity of this membrane material, its biocompatibility is still a matter of major concern. The contact of blood proteins and cells with HFM surface activates inflammatory response (coagulation, fibrinolysis, complement cascade and kallikrein-kinin) and cellular elements such as platelet, neutrophils, monocytes, hemoglobin release through erythrocyte rupture.

The most widely used method for improving biocompatibility of polysulphone membranes is the use of additives having excellent biocompatibility than the native polymer. Polysulphone blended with polyvinylpyrrolidone (PVP) showed enhanced biocompatibility than native Psf. Ishihara et al. prepared a phospholipid polymer having a 2-methacryloyloxyethyl phosphorylcholine (MPC) unit. The MPC polymer was blended with Psf by solvent evaporation method. The platelet adhesion and protein adsorption were reduced and change in morphology of adherent platelets was suppressed.

Another critical issue of Psf hemodialyzer is oxidative stress produced by reactive oxygen species (ROS) during hemodialysis. ROS are largely produced by neutrophils and monocyte through protein and lipid oxidation. Increased ROS are thought to be involved in atherosclerosis, hypertension or chronic inflammatory diseases, nephritis. Preliminary studies employing the Psf membrane and antioxidant agent such as vitamin E have showed significant improvement in neutrophil function, hematocrit and quality of life. Sasaki modified Psf membranes by coating them with vitamin E solution by dipping and drying so as to attach vitamin E, whereby the antioxidative activity was increased significantly than the native Psf. The hydrophobicity of vitamin E imparts resistance to flux. The coating of vitamin E to the inner surface of the hollow fiber may partially block and reduce the pore dimension present on the surface. The combined effect may lead to decline in separation performance of the membranes. Our approach described here overcomes this limitation. We have developed high flux composite polysulphone hollow fiber membrane without compromising on its separation performance and improved biocompatibility by incorporating vitamin E TPGS.

### OBJECTS OF THE INVENTION

An object of this invention is to produce articles such as membranes having high flux and specific permeability. Yet another object of this invention is to develop a membrane with anti-oxidative property, which assists in reduction in platelet activation and high urea clearance when used in kidney dialysis devices.

A further object of this invention is directed to a process of preparing filaments from doped polysulphones for manufacturing such articles.

### SUMMARY OF THE INVENTION

This invention relates to composite biocompatible articles such as fibres, membranes, tubes, and sheets having enhanced permeability, made from a composition of polysulphone and Vitamin E polyethylene glycol succinate herein after referenced as ETPGS™ namely D-Alpha-Tochopheryl polyethylene glycol succinate.

The composition may be spun into hollow filaments by conventional methods. 5 wt % to 25 wt % of ETPGS based on the weight of polysulphones may be used in the production of filaments, membranes, tubes and sheets may be made from the spun filaments by conventional methods.

The concentration of ETPGS may be 1 to 40% by weight of total weight of polysulphone and organic solvent.

Preferably, flat sheets and articles of different configuration having dimensions ranging from 1 mm to 10 nm are produced. It is also preferred to have articles having variable cross sections for enhancing selective permeability.

Yet another preferred embodiment is to produce an article having thick macro porous region and thin nano porous areas. The nano porous areas may be located either on the inner or the outer surface of the article.

This invention also relates to a process of preparing hollow filaments for making articles like membranes, sheets and tubes which comprises the steps of adding a solution of ETPGS to a solution of polysulphone in an organic solvent to produce a homogenous dope solution, extruding said dope solution coaxially with water through spinnerets to produce hollow filaments, passing said spun filament through an air gap and subsequently coagulating same to precipitate the filament and rinsing the same and forming shaped articles there from in a known manner.

PEG of the ETPGS complex has a molecular weight ranging from 400 to 40000 Da and is added in a concentration 1 to 40 wt % of the polysulphone and organic solvent. This organic solvent is selected from N-methylpyrrolidone, dimethylacetamide, dimethylformamide, dimethylsuphoxide and tetrahydrofuran.

The flow rate of the dope solution and the bore solution i.e. water is in the range from 0.5 to 10 mm/min and the air gap through which the spun filaments pass is between 0.1 to 100 cm. The coagulation is carried out in a medium of water and lower alcohols or a mixture thereof. Lower alcohols are selected from C₁ to C₅ alcohols. Coagulation bath temperature ranges from 5 to 30° C. The filaments are rinsed with water till free of adherent solvents and are wound at a speed of 1 to 60 m/min. Rinse bath temperature is from 25 to 50° C. Pure water permeability is from 16-54 ml/m²-hr-mm of Hg.

The produced hollow filaments exhibit the following properties:

Reactive oxygen species generation less than 50% when compared to fibres without the additives and platelet adherence less than 365±56×10⁴/cm² when incubated at 37° C. for 30 ml.

Membranes produced from this hollow fibre exhibit urea clearance 300 to 4500 mg/dl-m². When 100 mg/dl urea feed is circulated at 100 ml/min through lumen of hollow fibre and dialysis of phosphate buffer saline at the shell side at 200 ml/min.

The following examples 2 to 5 illustrate this invention while example 1 is a comparative example without the additive.

### EXAMPLES

### Example 1

Dope solution was prepared by dissolving polysulphone (Psf) in N-methylpyrrolidone (NMP) in order to make 25 wt % polymer solution. The mixture was stirred until clear homogeneous solution. Water was used as bore solution. The dope and bore solution was simultaneously extruded through coaxial spinneret at 2 ml/min and 2.5 ml/min pulseless flow rate respectively. The air gap was set at 45 cm. The fiber was passed through coagulation tank and rinse tank. Finally, hollow fiber membrane (HFM, P) was wound on take up drum at 3.89 m/min speed.

### Example 2

Dope solution was prepared by dissolving 5 wt % ETPGS and 25 wt % polysulphone in N-methylpyrrolidone (NMP, 70 wt %). The mixture was stirred until clear homogeneous solution. Water was used as bore solution. The dope and bore solution was simultaneously extruded through coaxial spinneret at 2 ml/min and 2.5 ml/min pulseless flow rate respectively. The air gap was set at 45 cm. The fiber was passed through coagulation tank and rinse tank. Finally, fiber (PT-5) was wound on take up drum at 3.89 m/min speed.

### Example 3

Dope solution was prepared by dissolving 10 wt % ETPGS and 25 wt % polysulphone in N-methylpyrrolidone (NMP, 70 wt %). The mixture was stirred until clear homogeneous solution. Water was used as bore solution. The dope and bore solution was simultaneously extruded through coaxial spinneret at 2 ml/min and 2.5 ml/min pulseless flow rate respectively. The air gap was set at 45 cm. The fiber was passed through coagulation tank and rinse tank. Finally, fiber (PT-10) was wound on take up drum at 3.89 m/min speed.

### Example 4

Dope solution was prepared by dissolving 15 wt % ETPGS and 25 wt % polysulphone in N-methylpyrrolidone (NMP, 70 wt %). The mixture was stirred until clear homogeneous solution. Water was used as bore solution. The dope and bore solution was simultaneously extruded through coaxial spinneret at 2 ml/min and 2.5 ml/min pulseless flow rate respectively. The air gap was set at 45 cm. The fiber was passed through coagulation tank and rinse tank. Finally, fiber (PT-15) was wound on take up drum at 3.89 m/min speed.

### Example 5

Dope solution was prepared by dissolving 20 wt % ETPGS and 25 wt % polysulphone in N-methylpyrrolidone (NMP, 70 wt %). The mixture was stirred until clear homogeneous solution. Water was used as bore solution. The dope and bore solution was simultaneously extruded through coaxial spinneret at 2 ml/min and 2.5 ml/min pulseless flow rate respectively. The air gap was set at 45 cm. The fiber was passed through coagulation tank and rinse tank. Finally, fiber (PT-20) was wound on take up drum at 3.89 m/min speed.

### Example 6

The hollow fiber membrane prepared using varying concentrations of ETPGS were tested for evaluation of biocompatibility. The biocompatibility test includes reactive oxygen species generation using NIH3T3 cells and complement activation. The results show that the biocompatibility of composite Psf/Vitamin E TPGS HFMs were improved. The number of platelet adhered to polysulphone and composite polysulphone membrane is tabulated in Table 1.

In-vitro urea diffusion test was carried out using 100 mg/dl urea concentration and urea clearance was improved with the additive concentration.

Table 1 shown below indicate that platelet adhesion is drastically reduced when membrane of this invention are used.

TABLE 1
The platelet adhered to the inner surface of polysulphone hollow fiber
without and with said additives, indicating platelet adhesion is
drastically reduced.

| Membrane Type | Platelet clusters × 10⁴/cm² | Platelet × 10⁴/cm² |
|---|---|---|
| P | 13 ± 4 | 2430 |
| PT-5 | — | 88 ± 19 |
| PT-10 | — | 64 ± 20 |
| PT-15* | — | 32 ± 5 |
| PT-20 | — | 63 ± 11 |

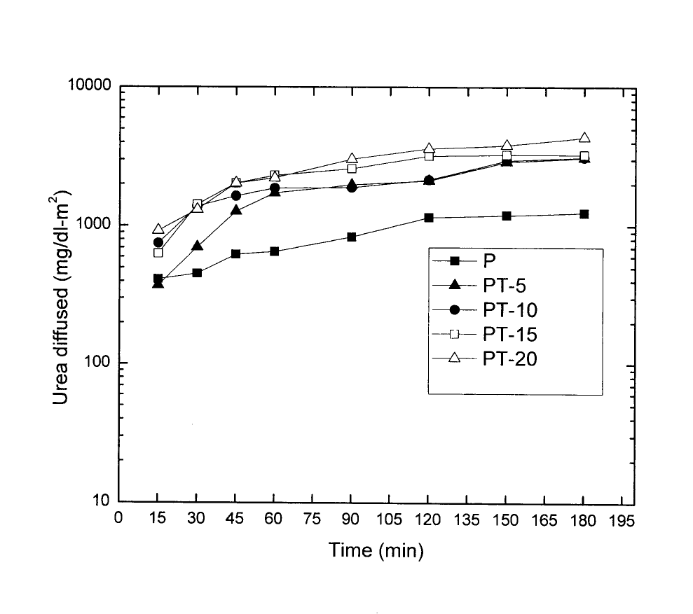

FIG. 1 shown in the accompanying sheet indicates the improvement in urea clearance when membranes of this invention are used.

The appended claims do not exclude obvious equivalents known to persons skilled in the art.

1. Composite biocompatible articles such as fibres, membrane, tubes, sheets and the like having enhanced permeability and high flux made from filaments spun from a composition of polysulphones and Vitamin E polyethylene glycol succinate, ETPGS.

2. The composite as claimed in claim 1 wherein the filaments are spun in a conventional manner and the composition has 5 wt % to 25 wt % of ETPGS based on the weight of polysulphone.

3. The composite as claimed in claims 1 and 2 wherein the polysulphone and the additives are separately dissolved in organic solvents selected from N-methylpyrrolidone, dimethylacetamide, dimethylformamide, dimethylsulphoxide and tetra hydrofuran.

4. The article as claimed in claims 1 to 3 wherein said article has macro porous and nano porous regions located either on the inner or outer surfaces.

5. The article as claimed in claims 1 to 4 wherein the PEG of ETPGS complex has a molecular weight ranging from 400 to 40000 Da.

6. A process for preparing hollow filaments for making articles like membranes, sheets and tubes comprising the steps of mixing a solution of Vitamin E TPGS to a solution of polysulphone in an organic solvent to produce a homogenous dope solution, extruding said dope solution coaxially with water through spinnerets to form hollow filaments, passing said filaments through an airgap before coagulating and precipitating the same, rinsing and winding the formed filaments and forming shaped articles therefrom in a known manner, if desired.

7. The process as claimed in claim 6, wherein the polyethylene glycol of ETPGS complex has a molecular range of 400 to 40000 Da and in present in the range of 1 to 40 wt % based on the total weight of polysulphone or organic solvent.

8. The process as claimed in claims 6 and 7 wherein the flow rate of the dope solution and water is in the range of 0.5 to 10 ml/min and the airgap is between 0.1 to 100 cm.

9. The process as claimed in claims 6 to 8 wherein the coagulation is carried out in a medium selected from water and lower alcohols of the range C₁ to C₅ or a mixture thereof at a temperature range of 5 to 30° C., the spun filaments are wound at a speed of 1 to 60 m/min after rinsing with water in a bath at a temperature of 25° C. to 50° C.

10. Filaments and articles made by a process as claimed in claims 6 to 9.
